(19) United States
(12) Patent Application Publication
(10) Pub. No.: US 2022/0190401 A1
(43) Pub. Date: Jun. 16, 2022

(54) ALL-SOLID-STATE LITHIUM-ION SECONDARY BATTERY AND LEAK INSPECTION METHOD USING SAME

(71) Applicant: HONDA MOTOR CO., LTD., Tokyo (JP)

(72) Inventors: Takuya TANIUCHI, Saitama (JP); Masahiro OHTA, Saitama (JP)

(21) Appl. No.: 17/644,088

(22) Filed: Dec. 13, 2021

(30) Foreign Application Priority Data
Dec. 16, 2020 (JP) 2020-208210

(51) Int. Cl. H01M 10/48; H01M 50/105; H01M 50/54; H01M 50/124

(52) U.S. Cl. CPC H01M 10/488; H01M 50/124; H01M 50/54; H01M 50/105

(57) ABSTRACT

An all-solid-state lithium-ion secondary battery which enables a leak inspection to be swiftly and simply performed is provided. The all-solid-state lithium-ion secondary battery includes an electrode laminate in which a positive electrode, a solid electrolyte layer, and a negative electrode are alternatingly laminated and disposed, a tab gathering section extended from the electrodes, and an exterior film which clads the electrode laminate and the tab gathering section. The electrode laminate and the tab gathering section are vacuum packaged by the exterior film. For example, it is possible to perform a leak inspection of the all-solid-state lithium-ion secondary battery by a recess for inspection formed by the exterior film following along a recess formed in the surface on the electrode laminate side being present, and measuring displacement of this recess for inspection.

This application is based on and claims the benefit of priority from Japanese Patent Application No. 2020-208210, filed on 16 Dec. 2020, the content of which is incorporated herein by reference.

### BACKGROUND OF THE INVENTION

### Field of the Invention

The present invention pertains to an all-solid-state lithium-ion secondary battery and a leak inspection method using the all-solid-state lithium-ion secondary battery.

### Related Art

Conventionally, lithium-ion secondary batteries are widespread as secondary batteries having high energy density. A liquid lithium-ion secondary battery has a cell structure in which a separator is caused to be present between a positive electrode and a negative electrode, and the cell is filled with a liquid electrolyte (electrolytic solution). In addition, in the case of an all-solid-state battery in which the electrolyte is solid, there is a cell structure in which a solid electrolyte is present between a positive electrode and a negative electrode. A lithium-ion secondary battery is configured by laminating a plurality of this single cell. Each of this plurality of cells is subjected to sealed packaging in an exterior film (this state is referred to below as a laminate cell). It is necessary to ensure the degree of sealing of these laminate cells in accordance with a leak inspection.

A lithium-ion secondary battery in which the electrolyte is a liquid is sealed by the exterior film, but the inside is not in a vacuum state. Accordingly, by putting a packaged cell into a vacuum state, by detecting, for example, an encapsulated gas or confirming the presence or absence of an expansion of volume of a laminate cell, it is possible to perform a leak check, in other words detect the presence of a crack or pinhole in the exterior film (refer to Patent Document 1).

Meanwhile, in the case of an all-solid-state lithium-ion secondary battery, because gas is not generated internally and because vacuum packaging is performed, there is the problem in that it is not possible to perform a leak inspection by putting a packaged cell into a vacuum state.

In respect to this, performing a visual inspection by capturing, as an image, a protrusion or depression occurring in the exterior film of a battery is known (refer to Patent Document 2).

Patent Document 1: Japanese Unexamined Patent Application, Publication No. 2019-039772

Patent Document 2: Japanese Unexamined Patent Application, Publication No. 2015-065178

### SUMMARY OF THE INVENTION

The visual inspection as disclosed in Patent Document 2 requires image inspection to be performed for the entirety of a cell without omission, and is therefore excessive. In addition, because a protrusion or a depression does not necessarily occur in a leak inspection, this is not an inspection method suitable for leak inspection.

The present invention is made in light of the above, and an object of the present invention is to provide an all-solid-state lithium-ion secondary battery which enables a leak inspection to be swiftly and simply performed, and a method of inspecting this all-solid-state lithium-ion secondary battery.

The inventors, et al. completed the present invention after finding that, by intentionally providing unevenness for leak inspection on an exterior film and detecting this unevenness before and after vacuum packaging, it was possible to specify a location for leak inspection and visually discover a leak, m other words, the present invention provides the following.

(1) An all-solid-state lithium-ion battery, including: a solid-state battery provided with an electrode laminate in which a positive electrode, a solid electrolyte layer, and a negative electrode are alternatingly laminated and disposed, and a tab gathering section where a plurality of extensions are gathered behind each extension is extended from an end of a respective electrode; and
an exterior film that accommodates the solid-state battery, in which the solid-state battery is vacuum packaged by the exterior film, and
the surface of the exterior film has one or both of: a recess for inspection which is provided such that the exterior film follows along a recess on the surface side of the solid-state battery; and
a rib-shaped protrusion for inspection including a surplus section of the exterior film being folded back into a loop shape on the surface side of the solid-state battery.

By virtue of the invention according to (1), it is possible to easily and quickly perform a leak inspection by confirming, before and after vacuum packaging, displacement of a recess for inspection provided in advance or a protrusion for inspection provided in advance.

(2) The all-solid-state lithium-ion secondary battery according to (1), in which the recess for inspection and/or the protrusion for inspection is formed at a position where the tab gathering section is covered.

By virtue of the invention according to (2), because there is a larger amount of space at the position where the tab gathering section is covered in comparison to other sites, the position where the tab gathering section is covered is desirable because the amount of displacement for a recess for inspection or a protrusion for inspection becomes large. In addition, the position where the tab gathering section is covered does not impact restraints on a laminate cell, and therefore is desirably used because battery durability is not impacted.

(3) The all-solid-state lithium-ion secondary battery according to (1) or (2), in which a plurality of the recesses for inspection and/or the protrusions for inspection are provided.

By virtue of the invention according to (3), by providing the recess for inspection or the protrusion for inspection at a plurality of locations, it is possible to improve inspection accuracy.

(4) The all-solid-state lithium-ion secondary battery according to any one of (1) through (3), in which the positive electrode and the negative electrode are each provided with a current collector including a metal porous body, and the recess for inspection and/or the protrusion for inspection is formed along a recess and/or a protrusion formed in the current collector.

By virtue of the invention according to (4), it is easy to form a recess for inspection or a protrusion for inspection in the metal porous body in accordance with the three-dimensional structure and elasticity of the metal porous body.

(5) The all-solid-state lithium-ion secondary battery according to any one of (1) through (4), in which a protective member is formed between the recess for inspection and/or the protrusion for inspection, and the tab gathering section.

By virtue of the invention according to (5), by disposing the protective member as an intermediate layer, it is possible to prevent damage to a current collector foil or the exterior film due to displacement of unevenness in the exterior film.

(6) The all-solid-state lithium-ion secondary battery according to (5), in which a recess and/or a protrusion is formed on the surface of the protective member.

By virtue of the invention according to (6), it is possible to clarify in advance the position of a recess for inspection or a protrusion for inspection.

(7) The all-solid-state lithium-ion secondary battery according to (5), in which an elastic modulus of the protective member is lower than an elastic modulus for the surface of the electrode laminate.

By virtue of the invention according to (7), in accordance with making the elastic modulus of the protective member be lower, in other words by making deformation of the protective member be large and soft, it is possible to prevent damage to the current collector foil or the exterior film.

(8) An all-solid-state lithium-ion secondary battery leak inspection method for determining the presence or absence of a leak at a time of vacuum packaging, the method including: a first step comprising performing vacuum packaging, with an exterior film, of a solid-state battery provided with an electrode laminate in which a positive electrode, a solid electrolyte layer, and a negative electrode are alternatingly laminated and disposed, and a tab gathering section where a plurality of extensions are gathered after each extension is extended from an end of a respective electrode; and one or more of a first inspection step and a second inspection step,
the first inspection step comprising forming a recess on a surface side of the solid-state battery in advance of the first step, the exterior film following along the recess in the first step, and, after the first step, measuring a degree of release of the following in the recess by the exterior film as a displacement of a recess for inspection, and
the second inspection step comprising configuring, on a surface side of the solid-state battery in advance of the first step, a space rib section having a space inside by a surplus section of the exterior film being folded back, the exterior film configuring a protrusion for inspection in accordance with shrinkage of the space in the first step, and measuring displacement of the protrusion for inspection after the first step.

By virtue of the invention according to (8), it is possible to easily and quickly perform a leak inspection by measuring, before and after vacuum packaging, displacement of a recess for inspection provided in advance or a protrusion for inspection provided in advance.

### BRIEF DESCRIPTION OF THE DRAWINGS

FIG. 1 is a partial cross-sectional schematic diagram according to one embodiment which uses a foamed metal current collector in a lithium-ion secondary battery according to the present invention;

FIG. 2A is an enlarged cross section near a tab gathering section of FIG. 1, according to a first embodiment;

FIG. 2B is an enlarged cross section near the tab gathering section of FIG. 1, according to the first embodiment;

FIG. 3A is an enlarged cross section near the tab gathering section of FIG. 1, according to a second embodiment;

FIG. 3B is an enlarged cross section near the tab gathering section of FIG. 1, according to the second embodiment;

FIG. 4A is an enlarged cross section illustrating a first variation;

FIG. 4B is an enlarged cross section illustrating the first variation;

FIG. 5 is an enlarged cross section illustrating a second variation;

FIG. 6 is a cross-sectional schematic view illustrating a third variation;

FIG. 7 is an enlarged cross section near, the tab gathering section of FIG. 6; and

FIG. 8 is a cross-sectional schematic view illustrating a fourth variation.

### DETAILED DESCRIPTION OF THE INVENTION

Description is given below regarding embodiments according to the present invention while referring to the drawings. Details of the present invention are not limited to the description of the following embodiments.

### First Embodiment

### <Overall Configuration of Lithium-Ion Secondary Battery>

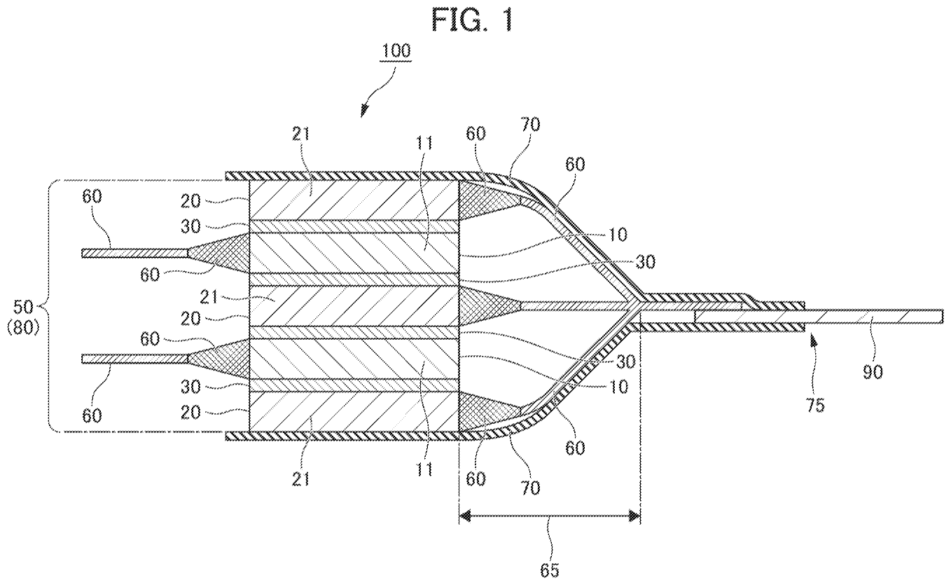

As illustrated in FIG. 1, a lithium-ion secondary battery 100 in FIG. 1 according to the present embodiment is an all-solid-state battery, and is provided with an electrode laminate 50 in which a positive electrode 10, a solid electrolyte layer 30, and a negative electrode 20 are alternatingly laminated and disposed.

The lithium-ion secondary battery 100 is provided with a tab gathering section 65 in which a plurality of extensions, which are each drawn from an end of a respective electrode current collector of the electrode laminate 50 and tapered, are gathered. The electrode laminate 50 and the tab gathering section 65 together configure a solid-state battery 80 as a whole. As illustrated in FIG. 1, the tab gathering section 65 is a site where a plurality of tabs 60 each extended from one end of a current collector are overlapped, and are gathered in order to join with a lead tab 90. The lead tab 90 is electrically connected to one end of the tab gathering section 65. In the present embodiment, it may be that a tab 60 is drawn from each electrode current collector. In other words, the tab gathering section 65 may be something extended from respective current collectors, or may be a member which differs from the current collectors. A material which can be used for the tab gathering section 65 is not limited in particular. It is possible to use material similar to that used in a conventional secondary battery.

Note that, in the present invention, an electrode current collector may be a current collector foil or may be a current collector which uses a metal porous body, but in the following embodiments, description is given regarding an example in which a metal porous body is used as an electrode current collector.

The electrode laminate 50 and the tab gathering section 65 are accommodated within an exterior film 70 configured by a bag-shaped laminate film, an opening 75 is subsequently heat sealed, and the electrode laminate 50 and the tab gathering section 65 are sealed with conventionally known vacuum packaging (refer to the right-side end of the electrode laminate 50 in FIG. 1). Note that the left side end of the electrode laminate 50 in FIG. 1 is in fact also sealed in the exterior film 70, but this is omitted in FIG. 1.

Description is given below regarding each constituent member.

### <Positive Electrode and Negative Electrode>

In this embodiment, the positive electrode 10 and the negative electrode 20 are respectively provided with a first current collector 11 and a second current collector 21 each configured by a metal porous body having holes (communication holes) that are mutually contiguous.

An electrode mixture (positive electrode mixture) and an electrode mixture (negative electrode mixture) which include electrode active material are respectively filled and disposed in the holes in the first current collector 11 and the second current collector 21. Conversely, the tab gathering section 65 and the lead tab 90 are unfilled regions in which an electrode mixture is not filled and disposed.

### (Current Collectors)

The first current collector 11 configuring a positive electrode current collector and the second current collector 21 configuring a negative electrode current collector are configured by metal porous bodies having holes which are mutually contiguous. By the first current collector 11 and the second current collector 21 having mutually contiguous holes, it is possible to fill the positive electrode mixture and the negative electrode mixture which include an electrode active material within the holes, and it is possible to increase the amount of electrode active material per unit area for an electrode layer. The metal porous body described above is not limited in particular as long as there is something which has mutually contiguous holes, and may have a form such as a foamed metal having holes in accordance with foaming, a metal mesh, expanded metal, punched metal, or metal non-woven fabric, for example.

A metal used in the metal porous body is not particularly limited as long as the metal has electrical conductivity, and may be nickel, aluminum, stainless steel, titanium, copper, or silver, for example. From these, it is possible to desirably use foamed aluminum, foamed nickel, or foamed stainless steel as a current collector which makes up a positive electrode, and desirably use foamed copper or foamed stainless steel as a current collector which makes up a negative electrode.

By using the first current collector 11 and the second current collector 21, it is possible to increase the amount of active material per unit area for an electrode, and as a result it is possible to improve the volumetric energy density of a lithium-ion secondary battery. In addition, because it becomes easier to fix the positive electrode mixture and the negative electrode mixture, when making an electrode mixture layer be thicker, there is no necessity to increase the viscosity of a coating slurry for forming the electrode mixture layer, which differs to with an electrode which uses a conventional metal foil as a current collector. Accordingly, it is possible to reduce the amount of a binder such as an organic polymer compound which was necessary to increase the viscosity. Accordingly, it is possible to increase the capacity per unit area for an electrode, and it is possible to realize a higher capacity for a lithium-ion secondary battery.

### (Electrode Mixture)

The positive electrode mixture and the negative electrode mixture are disposed in the holes formed inside the first current collector 11 and the second current collector 21, respectively. The positive electrode mixture and the negative electrode mixture respectively include a positive electrode active material and a negative electrode active material as essential components.

### (Electrode Active Material)

The positive electrode active material is not particularly limited as long as it is possible to occlude and discharge lithium ions, but may be LiCoCoO₂, Li (Ni_{5/10}Co_{2/10}Mn_{3/10}) O₂, Li (Ni_{6/10}Co_{2/10}Mn_{2/10}) O₂, Li (Ni_{8/10}Co_{1/10}Mn_{1/10}) O₂, Li (Ni_{0.8}Co_{0.15}Al_{0.05}) O₂, Li (Ni_{1/6}Co_{4/6}Mn_{1/6}) O₂, Li (Ni_{1/3}CO_{1/3}Mn_{1/3}) O₂, LiCoO₄, LiMn₂O₄, LiNiO₂, LiFePO₄, lithium sulfide, or sulfur, for example.

The negative electrode active material is not particularly limited as long as it is possible to occlude and discharge lithium ions, but may be metallic lithium, a lithium alloy, a metal oxide, a metal sulfide, a metal nitride, Si, SiO, or a carbon material such as artificial graphite, natural graphite, hard carbon, or soft carbon, for example.

### (Other Components)

The electrode mixture may optionally include other components besides an electrode active material and ion-conducting particles. These other components are not particularly limited, and may be components that can be used when manufacturing a lithium-ion secondary battery. For example, the other components may be a conductive aid or a binder, for example. It is possible to give acetylene black, for example, as an example of a conductive aid for a positive electrode, and it is possible to give polyvinylidene fluoride, for example, as a binder for the positive electrode. It is possible to give sodium carboxymethyl cellulose, styrene butadiene rubber, or sodium polyacrylate, for example, as an example of a binder for the negative electrode.

### (Method of Manufacturing Positive Electrode and Negative Electrode)

The positive electrode 10 and the negative electrode 20 are each obtained by filling an electrode mixture in the holes of a metal porous body which has mutually contiguous holes and which is a current collector. Firstly, the electrode active material, and additionally a binder or aid as necessary, are uniformly mixed by a conventionally known method to obtain an electrode mixture composition which has been adjusted to a predetermined viscosity and is desirably paste-like.

Next, with the abovementioned electrode mixture composition as the electrode mixture, the holes of the metal porous body which is a current collector is filled. The method of filling the electrode mixture in the current collector is not limited in particular, and, for example, a method of using a plunger type die coater to apply pressure and fill a slurry which includes the electrode mixture inside the holes of the current collector may be given. In addition to the above, an ion conductor layer may be impregnated inside the metal porous body by a dip method.

Note that, in the present; invention, a current collector is not limited to a metal porous body, and it is possible to use a conventionally known metal foil, for example. For a metal used in a metal foil, it is possible t.o use a metal which is similar to the metal porous body described above.

### <Solid Electrolyte Layer>

As illustrated in FIG. 1, in the present invention, a solid electrolyte layer 30 is formed between a positive electrode 10 and a negative electrode 20.

The solid electrolyte making up the solid electrolyte layer 30 is not particularly limited, and the solid electrolyte can be a sulfide-based solid electrolyte material, an oxide-based solid electrolyte material, a nitride-based solid electrolyte material, or a halide-based solid electrolyte material, for example. In the case of a lithium-ion battery, for example, a sulfide-based solid electrolyte material may be an LPS halogen (Cl, Br, I), Li₂S—P₂S₅, or Li₂S—P₂S₅—LiI, for example. Note that the above language “Li₂S—P₂S₅” means a sulfide-based solid electrolyte material formed by using a raw material composition including Li₂S and P₂S₅, and it is similar for other language. In the case of a lithium-ion battery, for example, it is possible for an oxide-based solid electrolyte material to be a NASICON oxide, a garnet oxide, or a perovskite oxide, for example. As a NASICON oxide, for example it is possible to give an oxide which includes Li, Al, Ti, P, and O (for example, Li_{1.5}Al_{0.5}Ti_{1.5}(PO₄)₃). As a garnet oxide, for example it is possible to give an oxide which includes Li, La, Zr, and O (for example, Li₇La₃Zr₂O₁₂). As a perovskite oxide, for example it is possible to give an oxide which includes Li, La, Ti, and O (for example, LiLaTiO₂).

### <Exterior Film>

The exterior film 70 is an exterior body which is in close contact with and is fixed to the electrode laminate 50 by vacuum, packaging, and accommodates the electrode laminate 50 and the tab gathering section 65. By sealing and accommodating the electrode laminate 50 and the tab gathering section 65, it is possible to prevent air from penetrating into the solid-state battery 80.

The exterior body is formed after forming the exterior film 70 to have a bag shape. It is desirable for the exterior film 70 to be a film which enables airtightness to be provided for the exterior body. The exterior film 70 may be a single-layer film, or may be a laminate comprising a plurality of layers.

It is desirable for the exterior film 70 to be provided with a barrier layer comprising, for example, a metal foil including a metal such as aluminum, a metal thin film including a metal such as aluminum, and an inorganic oxide thin film including, for example, silicon oxide or aluminum oxide. By the exterior film 70 being provided with a barrier layer, it is possible for the exterior film 70 to provide airtightness as an exterior body.

It is desirable for the exterior film 70 to be provided with a seal layer comprising a thermoplastic resin such as a polyethylene resin or a polypropylene resin. By causing seal layers laminated on films to oppose each other and fuse to each other, it is possible to join the films to each other. Accordingly, a step for applying an adhesive becomes unnecessary. Note that the exterior film 70 does not need to be provided with a seal layer. It is possible to form an exterior body by joining films to each other in accordance with an adhesive.

For the exterior film 70, it is possible to give an example of a laminate in which a base material layer comprising, for example, polyethylene terephthalate, polyethylene naphthalate, nylon, or polypropylene, the barrier layer described above, and the seal layer described above are laminated. These layers may be laminated with a conventionally known adhesive therebetween, or may be laminated in accordance with extrusion coating, for example.

A desirable thickness of the exterior film 70 differs in accordance with the material used for the film, but it is desirable for the thickness to be 50 μm or more, and more desirably 100 μm or more. A desirable thickness for the exterior film 70 is desirably 700 μm or less, and more desirably 200 μm or less. When within this range, film strength and flexibility can both be established, and it becomes easier to form, in the exterior film 70, a recess 71 for inspection, a protrusion 72 for inspection, and a protrusion contraction section for inspection, which are described below.

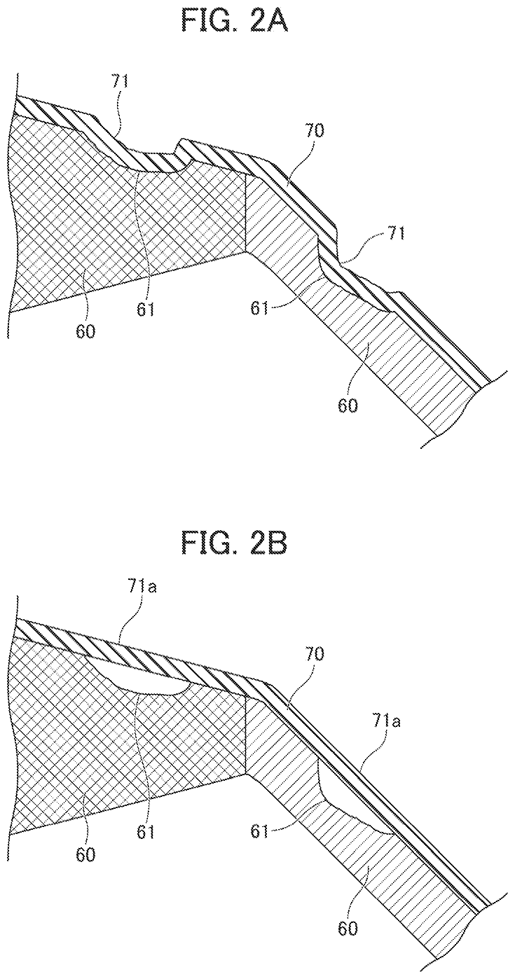

Next, description is given regarding a recess 71 for inspection of the exterior film 70, which is a feature of the present invention. FIGS. 2A and 2B are enlarged cross sections near the tab gathering section of FIG. 1, according to the first embodiment. FIG. 2A illustrates a state where vacuum packaging has been correctly performed, in other words the state of a good article. FIG. 2B illustrates a state in which the degree of vacuum is low and a leak has occurred, in other words the state of a defective article.

A plurality of recesses 61—two recesses 61 in the present embodiment—have been formed in advance in a tab 60 in the tab gathering section 65. These recesses 61, for example, can be formed by performing shaping or the like on the abovementioned current collector which comprises a metal porous body.

In the present embodiment, recesses 61 and protrusions 62 described below mean surface unevenness formed in a tab 60 in the tab gathering section 65. In contrast, recesses 71 for inspection and protrusions 72 for inspection which are described below mean surface unevenness seen from the exterior film 70 side, and each type of recess and protrusion is distinguished.

In the close-contact following state in FIG. 2A, it is desirable for the size of a recess 71 for inspection to have a diameter of 0.1 mm to 10 mm (inclusive) when expressed as a circle in a plan view, with the depth of the deepest depression being 0.01 mm to 1 mm (inclusive)

When describing in detail below the actual method of a leak inspection in order, firstly, as described above, a recess 61 is formed in advance in the surface of a tab 60 in the tab gathering section 65, in the solid-state battery 80.

Next, the exterior body (exterior bag) is manufactured by forming the exterior film 70 into a bag shape which has an opening 75, with heat sealing for example. The solid-state battery 80 is then accommodated within the exterior body. At this stage, the exterior film 70 is flat, without, following or being in close contact within the recess 61, as illustrated in FIG. 2B. Specifically, a pre-inspection planar section 71a in FIG. 2B is configured, but a defective inspection recess 71a is configured later.

Next, in a first step, a vacuum packaged body is obtained by performing sealed packaging with heat sealing, for example, on the opening 75 in a vacuum state. Vacuum packaging can be performed using a conventionally known vacuum packaging machine. At this point, the inside of the exterior body configured by the exterior film 70 becomes a vacuum, and in a state where vacuum packaging is correctly performed as illustrated in FIG. 2A, the exterior film 70 follows and comes into close contact with the inside of the recess 61 to configure the recess 71 for inspection. If this vacuum state can be maintained, this following will be maintained even after the exterior film 70 is exposed to the atmosphere. In other words, the lithium-ion secondary battery 100 is provided with a recess 71 for inspection on the surface of the exterior film 70 which covers the vicinity of the tab gathering section 65. This is the state of a good article.

When, hypothetically, a defect such as a pinhole is present in either the exterior film 70 or the exterior body thereof, when there is exposure to the atmosphere after vacuum packaging, the exterior film 70 ceases to maintain a vacuum state, the following is released, and the exterior film 70 returns again to the flat state as illustrated by the defective inspection recess 71a in FIG. 2B, in other words returns to a state where there is no following and no close contact.

In a first inspection step, by measuring the amount of displacement of the depression in the recess 71 for inspection in the exterior film 70, specifically the amount of displacement from the recess 71 for inspection to the defective inspection recess 71a, it is possible to simply and quickly perform a leak inspection of the lithium-ion secondary battery 100. The article is considered good if the amount of displacement is zero or low, and the article is considered defective if the amount of displacement is large.

The amount of displacement may be measured as the height of the depression, may be measured as the sire (area) of the depression, may be measured as the slope of the depression, or may be measured by a combination of these or through image processing. In the present invention, because the recess 71 for inspection is at a predetermined position, it is possible to perform a leak determination by measuring only this inspection point.

Note that measurement in the present invention is not only measurement by a device using an image or a laser, for example, but includes a determination made in accordance with visual observation. In addition to the presence or absence of a depression, a value for a predetermined depression amount may be used as a threshold in a pass/fall determination criterion for the amount of displacement.

Because the recess 71 for inspection and the later-described protrusion 72 for inspection in the present invention are on the “surface side of the solid-state battery”, the meaning is that the recess 71 for inspection and the protrusion 72 for inspection may be formed on the surface of the electrode laminate 50 or on the surface of a later-described protective member 95 in addition to on the tab gathering section 65 as in the present embodiment, but are desirably on the surface of the exterior film 70 which covers the tab gathering section 65. Because there is a larger amount of space inside the tab gathering section 65 in comparison to other sites, a position where the tab gathering section is covered is desirable because the amount of displacement for a recess for inspection or a protrusion for inspection becomes large. In addition, a position where the tab gathering section is covered does not impact the restraints on a laminate cell, and therefore is particularly desirably employed so that battery durability is not also impacted.

It is desirable to provide a plurality of the recess 71 for inspection and the later-described protrusion 72 for inspection. By the recesses 71 for inspection end the protrusions 72 for inspection being provided at a plurality of locations, it is possible to improve inspection accuracy.

It is desirable to form the recess 71 for inspection and the later-described protrusion 72 for inspection as a recess 61 or a protrusion 62 in the surface of a current collector configured by a metal porous body. It is easy to form a recess for inspection or a protrusion for inspection in the metal porous body in accordance with the three-dimensional structure and elasticity of the metal porous body.

### Second Embodiment

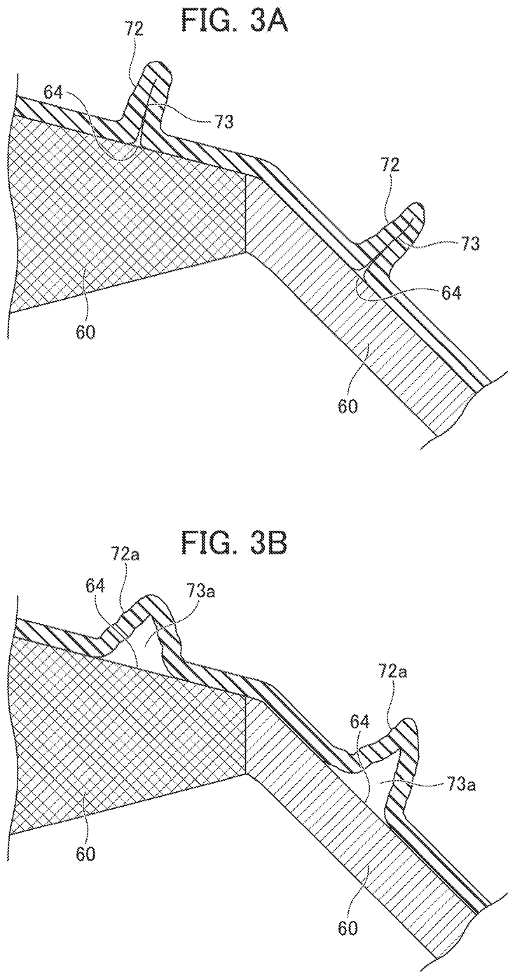

FIGS. 3A and 3B are enlarged cross sections near the tab gathering section of FIG. 1, according to a second embodiment. This embodiment is an example in which a protrusion 72 for inspection is formed in place of a recess 71 for inspection. The same reference symbols are applied below to configurations similar to those in the first embodiment, and description thereof is omitted.

FIGS. 3A and 3B are enlarged cross sections near the tab gathering section of FIG. 1, according to a second embodiment. FIG. 3A illustrates a state where vacuum packaging has been correctly performed, in other words the state of a good article. FIG. 3B illustrates a state in which the degree of vacuum is low and a leak has occurred, in other words the state of a defective article.

When describing in detail below the actual method of a leak inspection in order, firstly, as described above, in the present embodiment, in the solid-state battery 80, an uneven section is not formed in advance in a tab 60 in the tab gathering section 65, and a section 74 scheduled to be inspected is configured by a flat section in FIG. 3B.

Next, the exterior body (exterior bag) is manufactured by forming the exterior film 70 into a bag shape which has an opening 75, with heat sealing for example. The solid-state battery 80 is then accommodated within the exterior body. At this stage, as illustrated in FIG. 3B, a surplus section of the exterior film 70 is folded back into an approximately triangular shape on the section 74 scheduled to be inspected which is a portion of the surface of a tab 60 of the solid-state battery 80, and a rib-shaped pre-inspection protrusion 72a (detected later as a defective inspection protrusion 72) configured by being provided with a space 73a inside is formed in advance. The pre-inspection protrusion 72a may be formed by, for example, embossing the exterior film 70 in advance, or may be formed at a time of accommodation.

Next, in a first step, a vacuum packaged body is obtained by performing sealed packaging with heat sealing, for example, on the opening 75 in a vacuum state. At this point, the inside of the exterior body configured by the exterior film 70 becomes a vacuum, and, as illustrated in FIG. 3A, the space 73a is evacuated to thereby shrink and become an unjoined close-contact section 73, and the pre-inspection protrusion 72a configures a rib-shaped protrusion 72 for inspection which is configured by the surplus section of the exterior film 70 being folded back into a loop shape. If the vacuum state can be maintained, the protrusion 72 for Inspection will be maintained even after being exposed to the atmosphere. In other words, the lithium-ion secondary battery 100 is provided with a protrusion 72 for inspection on the surface of the exterior film 70 which covers the vicinity of the tab gathering section 65. This is the state of a good article.

If, hypothetically, a defect such as a pinhole is present in either the exterior film 70 or the exterior body thereof, when there is exposure to the atmosphere after vacuum packaging, the exterior film 70 ceases to maintain a vacuum state, the unjoined close-contact section 73 is released, and the exterior film 70 returns again to the state of the defective inspection protrusion 72a in FIG. 3B.

In a second inspection step, by measuring the amount of displacement of the protrusion 72 for inspection in the exterior film 70, specifically the amount of displacement from the protrusion 72 for inspection to the defective inspection protrusion 71a, it is possible to simply and quickly perform a leak inspection of the lithium-ion secondary battery 100. The article is considered good if the amount of displacement is zero or low, and the article is considered defective if the amount of displacement is large.

The amount of displacement may be measured as the height of the protrusion, may be measured as the spread (area) of the protrusion in a plan view, may be measured as the slope of the protrusion, or may be measured by a combination of these or through image processing. Of these, the displacement of the area of the protrusion is large and easy to detect and is thus desirable. In the present invention, because the protrusion 72 for inspection is at a predetermined position, it is possible to perform a leak determination by measuring only this inspection point.

Regarding the size of a protrusion 72 for inspection, it is desirable for the height of the protrusion to be 0.05 mm to 5 mm (inclusive) in the state of FIG. 3A.

### First Variation

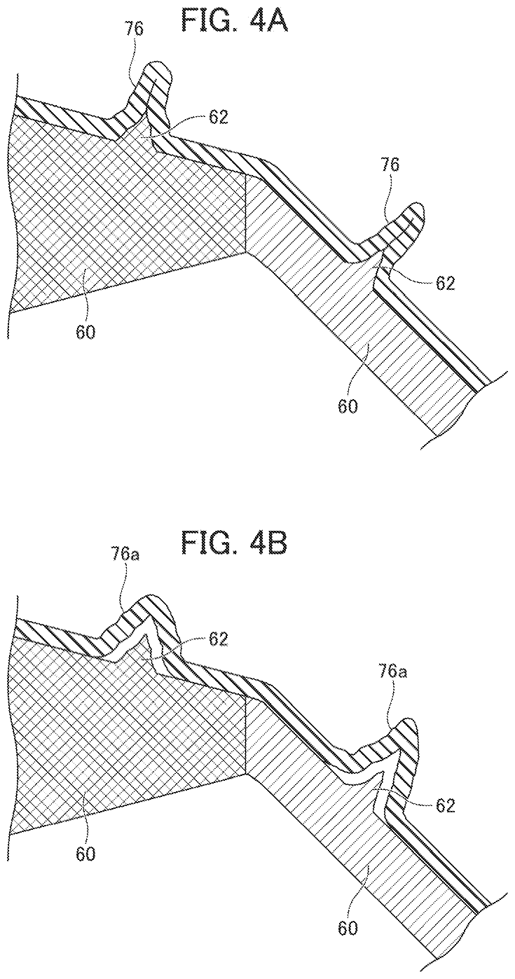

FIGS. 4A and 4B illustrate an example in which the space 73a in FIG. 3B is not a complete space, and a protrusion 62 on the surface of the current collector having a metal porous body is formed at the position of the space 73a, in the second embodiment. Even in this case, a protrusion 76 for inspection is formed, as illustrated in FIG. 4A. In this case, if there is a leak, the close-contact state of the exterior film 70 relaxes, and a defective inspection protrusion 76a is formed, as illustrated in FIG. 4B. In the present embodiment, it is desirable for the position of a protrusion for inspection to be clarified in advance. The protrusion 62 can be easily formed by, for example, embossing the surface of the current collector.

In this case, regarding the size of a protrusion 76 for inspection, it is desirable for the height of the protrusion to be 0.05 mm to 10 mm (inclusive) in the state of FIG. 4A.

### Second Variation

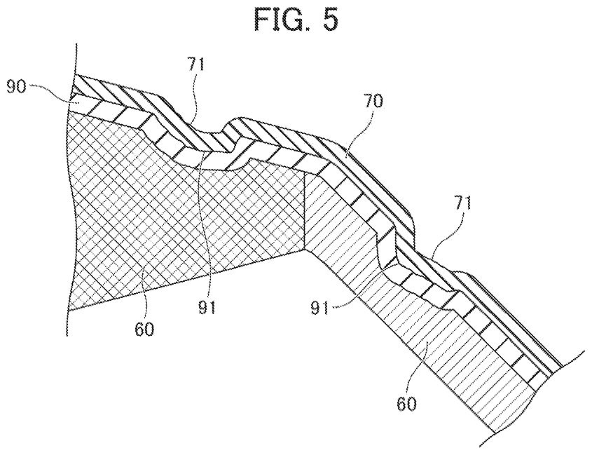

FIG. 5 is a variation of FIG. 2A in the first embodiment. In the present variation, a protective member 90 is provided as an intermediate layer between the exterior film 70 and a tab 60.

In this case, as illustrated in FIG. 5, in a state where vacuum packaging is correctly performed, the exterior film 70 follows and is in close contact within a recess 91 in the protective member 95, and a recess 71 for inspection is configured. In the present embodiment, it is also desirable for the position of a protrusion for inspection to be clarified in advance. Note that, although a recess is formed in the surface of a protective member in the present variation, there is no limitation to this, and a protrusion may be formed.

In this manner, by disposing the protective member 95 as an intermediate layer, it is possible to prevent damage to a current collector foil or the exterior film due to displacement of unevenness in the exterior film. Mote that it is particularly desirable to use the protective member 95 in a case where the current collector is a foil because, in the case where the current collector is a metal porous body, the metal porous body itself has a buffering action.

It is desirable for the elastic modulus of the protective member to be lower than the elastic modulus for the surface of the electrode laminate. By making the elastic modulus of the protective member be lower, in other words by making deformation of the protective member be large and soft, it is possible to prevent damage to the current collector foil or the exterior film. It is possible to exemplify, for example, a resin such as an elastomer as a specific example for the protective member. The protective member is not just a molded member, and may be formed in accordance with coating. When the protective member is coated, it is possible to dispose the protective member more easily than with a molded article, and it is possible to maintain the flexibility of the current collector.

### Third Variation

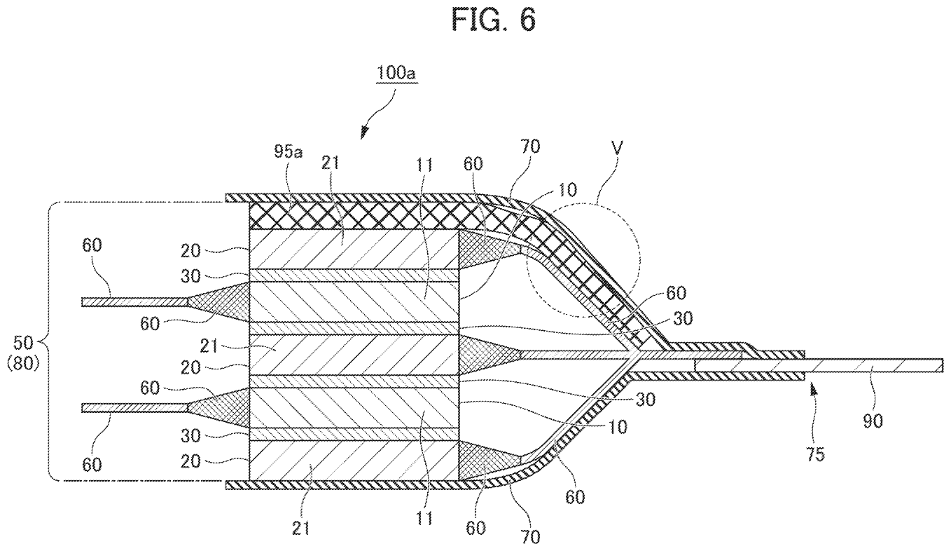

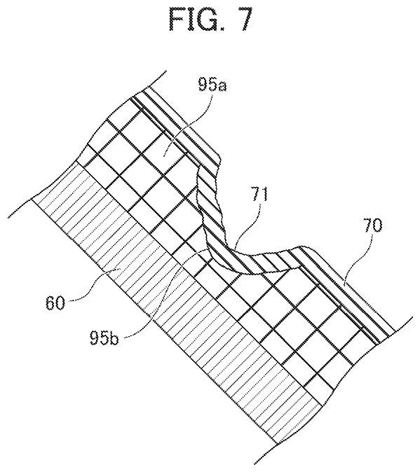

A lithium-ion secondary battery 100 in FIG. 6 is an example in which the metal porous body used for a current collector as described above is used as a protective member 95a. FIG. 7 is an enlarged view of a region V in FIG. 6. A recess 95b is provided in the surface of the protective member 95a, and is similar to the recess 61 or the recess 91 described above. It is desirable for the metal porous body which configures the protective member 95a to have a buffering action with respect to external force on the lithium-ion secondary battery. In addition, in a case where a metal porous body is also used for a current collector, it is possible to effectively prevent lamination misalignment due to an anchor effect between the unevenness on the surfaces of both metal porous bodies which are laminated. The inside of the metal porous body for the protective member 95a may be filled with a resin, for example. As a result, it is possible to increase the strength of the protective member 95a.

Note that the recess 95b may be configured as a protrusion as with the protrusion 62 in the first variation described above. In addition, in the present variation, it is still the case that a current collector is not limited to a metal porous body and a metal, foil may be used.

### Fourth Variation

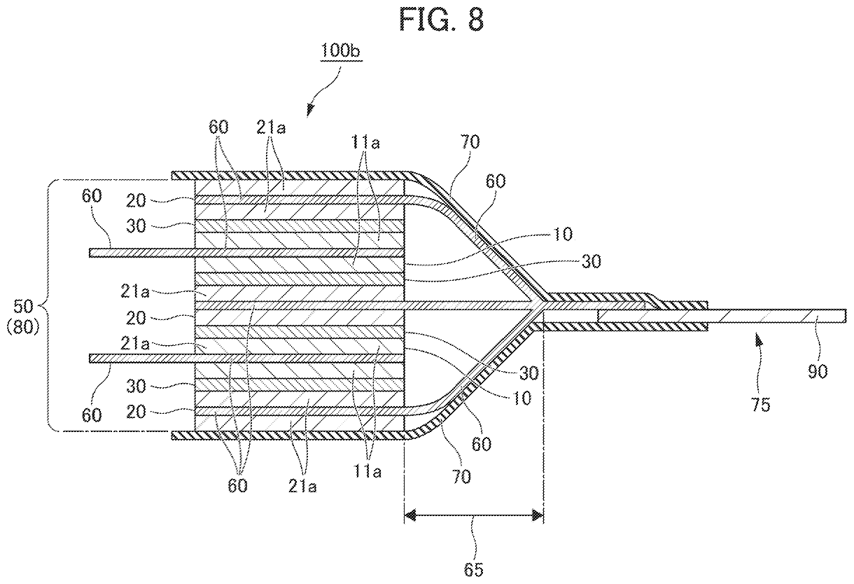

A lithium-ion secondary battery 100b in FIG. 8 differs from the first embodiment described above in that a current collector is configured by a metal foil instead of a metal porous body. In FIG. 8, a negative electrode mixture 21a is disposed on both sides of a current collector foil 60 for a negative electrode, and a positive electrode mixture 11a is disposed on both sides of a current collector foil 60 for a positive electrode.

In this variation, one end of a current collector foil 60 is extended to configure a tab 60 as is, and a plurality of tabs 60 are overlapped to configure the tab gathering section 65. In this manner, a current collector in the present invention is not limited to a metal porous body and may be a metal foil.

Desirable embodiments according to the present invention are described above, but the content of the present invention is not limited to the above embodiments, and can be changed, as appropriate.

### EXPLANATION OF REFERENCE NUMERALS

10 Positive electrode

11 First current collector (positive electrode current collector)

11a Positive electrode mixture

20 Negative electrode

21 Second current collector (positive electrode current collector)

21a Negative electrode mixture

30 Solid electrolyte layer

50 Electrode laminate

60 Tab (current collector foil)

61 Recess

62 Protrusion

65 Tab gathering section

70 Exterior film

71 Recess for inspection

71a Defective inspection recess (pre-inspection planar section)

72 Protrusion for inspection

72a Defective inspection protrusion (pre-inspection protrusion)

73 Unjoined close-contact section

73a Space

64 Section scheduled to be inspected

75 Opening

76 Protrusion for inspection

76a Defective inspection protrusion (pre-inspection protrusion)

60 Solid-state battery

90 Lead tab

95, 95a Protective member

95b Recess

100, 100a, 100b Lithium-ion secondary battery

V Region

What is claimed is:

1. An all-solid-state lithium-ion battery, comprising:
a solid-state battery provided with an electrode laminate in which a positive electrode, a solid electrolyte layer, and a negative electrode are alternatingly laminated and disposed, and a tab gathering section where a plurality of extensions are gathered behind each extension is extended from an end of a respective electrode; and
an exterior film that; accommodates the solid-state battery,
wherein the solid-state battery is vacuum packaged by the exterior film, and
the surface of the exterior film has one or both of:
a recess for inspection which is provided such that the exterior film follows along a recess on the surface side of the solid-state battery; and
a rib-shaped protrusion for inspection comprising a surplus section of the exterior film being folded back into a loop shape on the surface side of the solid-state battery.

2. The all-solid-state lithium-ion secondary battery according to claim 1, wherein the recess for inspection and/or the protrusion for inspection is formed at a position where the tab gathering section is covered.

3. The all-solid-state lithium-ion secondary battery according to claim 1, wherein a plurality of the recesses for inspection and/or the protrusions for inspection are provided.

4. The all-solid-state lithium-ion secondary battery according to claim 1, wherein
the positive electrode and the negative electrode are each provided with a current collector comprising a metal porous body, and
the recess for inspection and/or the protrusion for inspection is formed along a recess and/or a protrusion formed in the current collector.

5. The all-solid-state lithium-ion secondary battery according to claim 1, wherein a protective member is formed between the recess for inspection and/or the protrusion for inspection, and the tab gathering section.

6. The all-solid-state lithium-ion secondary battery according to claim 5, wherein a recess and/or a protrusion is formed on the surface of the protective member.

7. The all-solid-state lithium-ion secondary battery according to claim 5, wherein an elastic modulus of the protective member is lower than an elastic modulus for the surface of the electrode laminate.

8. An all-solid-state lithium-ion secondary battery leak inspection method for determining the presence or absence of a leak at a time of vacuum packaging, the method comprising:
a first step comprising performing vacuum packaging, with an exterior film, of a solid-state battery provided with an electrode laminate in which a positive electrode, a solid electrolyte layer, and a negative electrode are alternatingly laminated and disposed, and a tab gathering section where a plurality of extensions are gathered after each extension is extended from an end of a respective electrode; and
one or more of a first inspection step and a second inspection step,
wherein the first inspection step comprises forming a recess on a surface side of the solid-state battery in advance of the first step, the exterior film following along the recess in the first step, and, after the first step, measuring a degree of release of the following in the recess by the exterior film as a displacement of a recess for inspection, and
the second inspection step comprises configuring, on a surface side of the solid-state battery in advance of the first step, a space rib section having a space inside by a surplus section of the exterior film being folded back, the exterior film configuring a protrusion for inspection in accordance with shrinkage of the space in the first step, and measuring displacement of the protrusion for inspection after the first step.
